(19) United States
(12) Patent Application Publication
(10) Pub. No.: US 2026/0361379 A1
(43) Pub. Date: Nov. 12, 2026

(54) REDUCED OVERHEAD BEAM SELECTION PROCESS

(71) Applicant: NEWRACOM, Inc., Irvine, CA (US)

(72) Inventors: Heejung YU, Daejeon (KR); Joonsoo LEE, Irvine, CA (US); Si-Chan NOH, Seoul (KR); Il-Gu LEE, Seoul (KR)

(73) Assignee: NEWRACOM, Inc., Irvine, CA (US)

(21) Appl. No.: 19/670,931

(22) Filed: May 7, 2026

Related U.S. Application Data
(60) Provisional application No. 63/802,199, filed on May 8, 2025.

(51) Int. Cl. H04B 7/06; H04B 7/0408; H04B 7/0426; H04L 5/00

(52) U.S. Cl. CPC H04B 7/06952; H04B 7/0408; H04B 7/043; H04L 5/0007; H04L 5/0048

(57) ABSTRACT

Disclosed herein is a method performed by a transmitter to reduce the overhead of a beam selection process. The method includes transmitting a plurality of orthogonal long training field (LTF) streams to a receiver via a plurality of antennas in a first channel, with a different steering beam vector applied to each of the plurality of orthogonal LTF streams so that the plurality of orthogonal LTF stream is transmitted in a first plurality of beam directions, determining a first beam direction that has a highest signal quality among the first plurality of beam directions based on feedback received from the receiver, determining a second plurality of beam directions based on the first beam direction, and performing the beam selection process in the second plurality of beam directions in a second channel to determine a second beam direction that has a highest signal quality among the second plurality of beam directions.

### CROSS-REFERENCE TO RELATED APPLICATION

This application claims the benefit of U.S. Provisional Application No. 63/802,199, filed May 8, 2025, titled “Sub-7 GHz NDP aided millimeter wave beam selection mechanism for Integrated Millimeter Wave (IMMW) IEEE 802.11bq”, which is hereby incorporated by reference.

### TECHNICAL FIELD

The present disclosure generally relates to wireless communications, and more specifically, relates to a reduced overhead beam selection process.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

The integrated millimeter wave (IMMW) Wi-Fi standard (i.e., IEEE 802.11bq) has been proposed to secure wider bandwidths for Wi-Fi systems. Compared to the previous millimeter wave (mmWave) Wi-Fi standards such as IEEE 802.11ad/11ay, IEEE 802.11bq defines a non-standalone operation of mmWave with the support of sub-7 Gigahertz (GHz) multilink operation (MLO). Even though wider bandwidth can be secured in mmWave channels, a beamforming operation (i.e., directional transmission) is required to compensate for the severe propagation loss. Thus, a beam selection process (to find the best beam direction) has to be performed before performing a mmWave transmission. This beam selection process may involve the transmitter transmitting multiple training signals in different directions and a receiver feeding back an indication of the beam direction that has the highest received signal power at the receiver. The beam selection process can add significant overhead to mmWave operations.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 shows an example format of a null data packet (NDP) frame as defined in the IEEE 802.11be wireless networking standard.

FIG. 11 is a diagram showing four orthogonal long training field (LTF) streams being transmitted by four antennas, according to some embodiments.

FIG. 12 is a diagram showing four LTF streams being transmitted by a transmitter with four antennas, with different steering beam vectors being applied to each LTF stream, according to some embodiments.

FIG. 13 is a diagram showing four LTF streams being transmitted in different beam directions, according to some embodiments.

FIG. 14 is a diagram showing a millimeter wave (mmWave) beam selection process that uses a sub-7 Gigahertz (GHz) channel sounding process to reduce overhead, according to some embodiments.

FIG. 15 is a flow diagram showing a method for reducing the overhead of a beam selection process, according to some embodiments.

FIG. 16 is a flow diagram showing a method for participating in a reduced overhead beam selection process, according to some embodiments.

### DETAILED DESCRIPTION

The present disclosure generally relates to wireless communications, and more specifically, relates to a reduced overhead beam selection process.

As mentioned above, even though wider bandwidth can be secured in millimeter wave (mmWave) channels, a beamforming operation (i.e., directional transmission) is required to compensate for the severe propagation loss. Thus, a beam selection process (to find the best beam direction) has to be performed before performing a mmWave transmission. This beam selection process may involve the transmitter transmitting multiple training signals in different directions and a receiver feeding back an indication of the beam direction that has the highest receive signal power at the receiver. The beam selection process can add significant overhead to mmWave operations.

The present disclosure describes a technique to reduce the overhead of a beam selection process in the mmWave channel by making use of a channel sounding process in a sub-7 Gigahertz (GHz) channel.

According to some embodiments, a transmitter (beamformer) in a wireless network may transmit multiple orthogonal long training field (LTF) streams to a receiver (beamformee) in a sub-7 GHz channel (e.g., as part of a null data packet (NDP) frame transmission), with a different steering beam vector applied to each LTF stream so that the multiple LTF streams are transmitted in multiple beam directions. The receiver may generate feedback for the transmitter based on processing the multiple orthogonal LTF streams. This feedback may include information that the transmitter can use to determine the beam direction that has the highest signal quality among the multiple beam directions. For example, the feedback may include an indication of the LTF signature corresponding to the LTF stream or beam direction that has the highest signal quality (e.g., highest received signal power). The receiver may then transmit this feedback to the transmitter in the sub-7 GHz channel. The transmitter may use the feedback provided by the receiver to determine the beam direction that has the highest signal quality among the multiple beam directions, which it can consider to be the estimated direction from the transmitter to the receiver. The transmitter may then perform a beam selection process in the mmWave channel in multiple beam directions near the estimated direction from the transmitter to the receiver (instead of having to perform the beam selection process omnidirectionally) to determine the final beam direction in which to transmit beamformed signals to the receiver in the mmWave channel. In this way, the transmitter may perform a channel sounding process or similar process in the sub-7 GHz channel to estimate the direction from the transmitter to the receiver and use this result to reduce the overhead of the beam selection process in the mmWave channel (by focusing the beam selection process in the mmWave channel on beam directions that are near the estimated direction from the transmitter to the receiver).

The reduced overhead beam selection process is primarily described herein in the context of a wireless network that supports multi-link operation (MLO) in a sub-7 GHz channel and a mmWave channel. It should be appreciated, however, that the process is not limited to being used only in these particular channels/bands. It is contemplated that the process can be used in wireless networks supporting MLO in other channels/bands.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

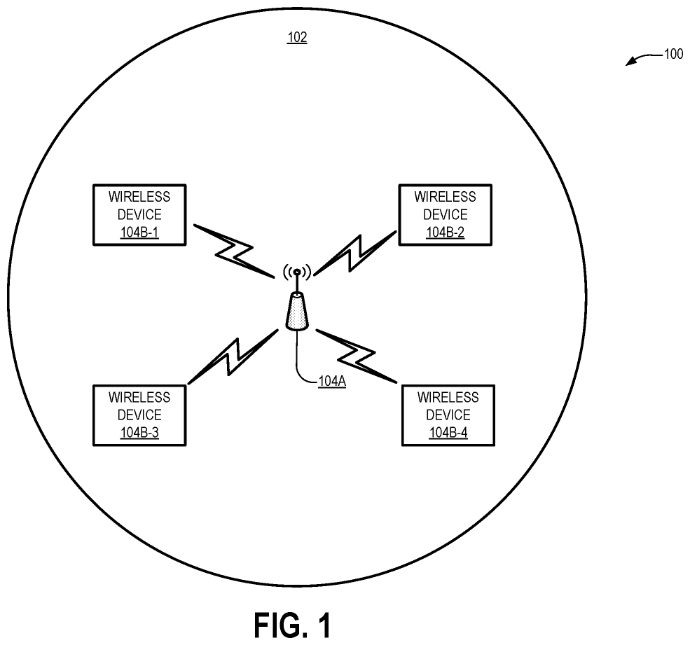

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART. request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

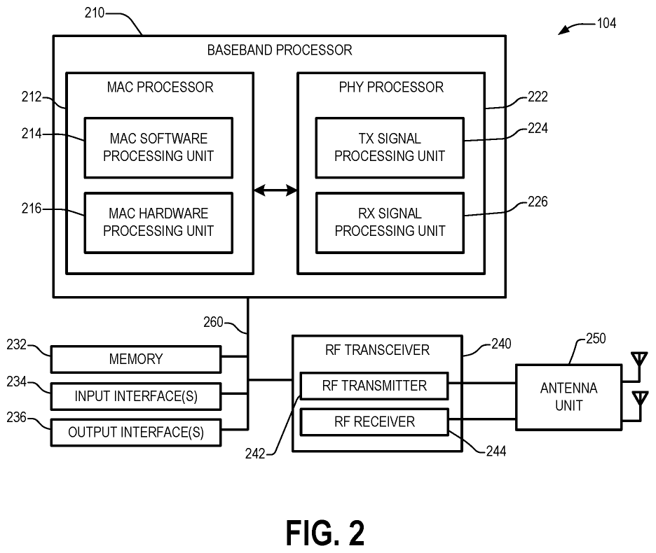

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

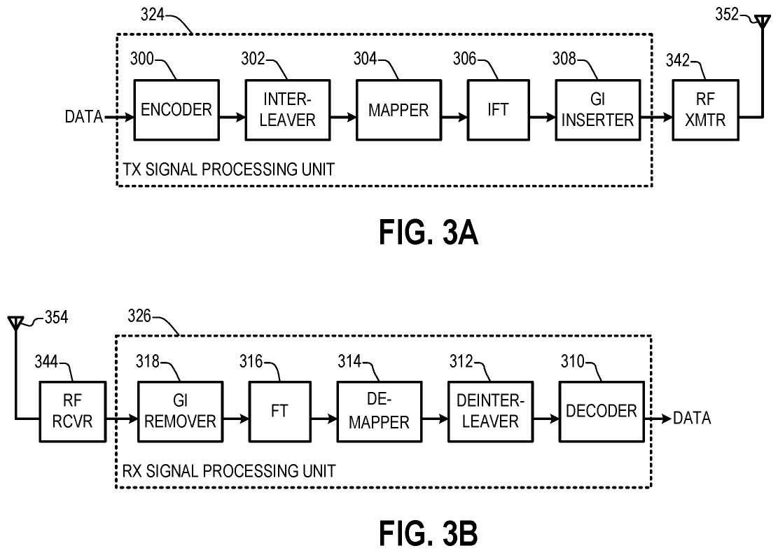

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

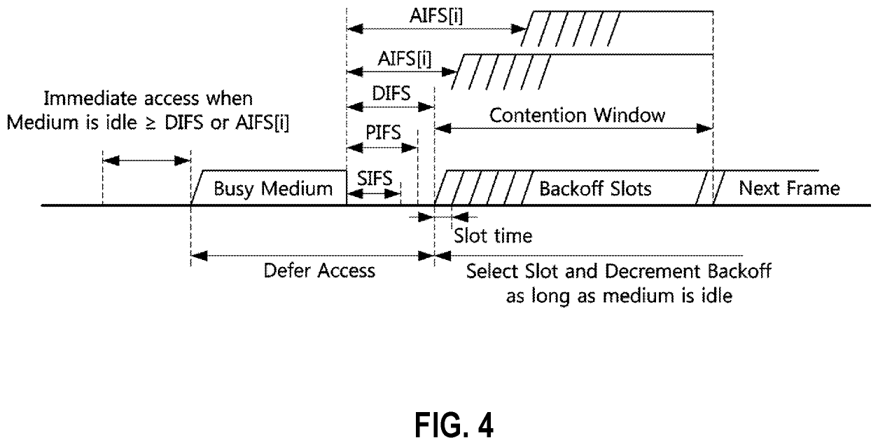

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

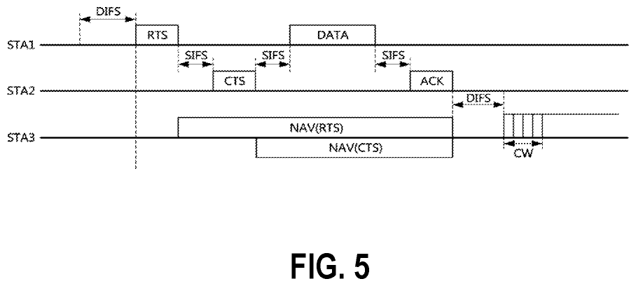

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

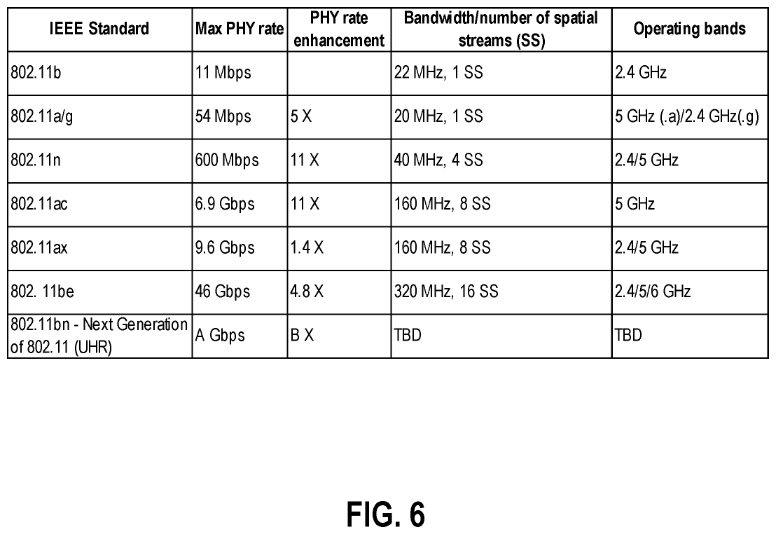

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

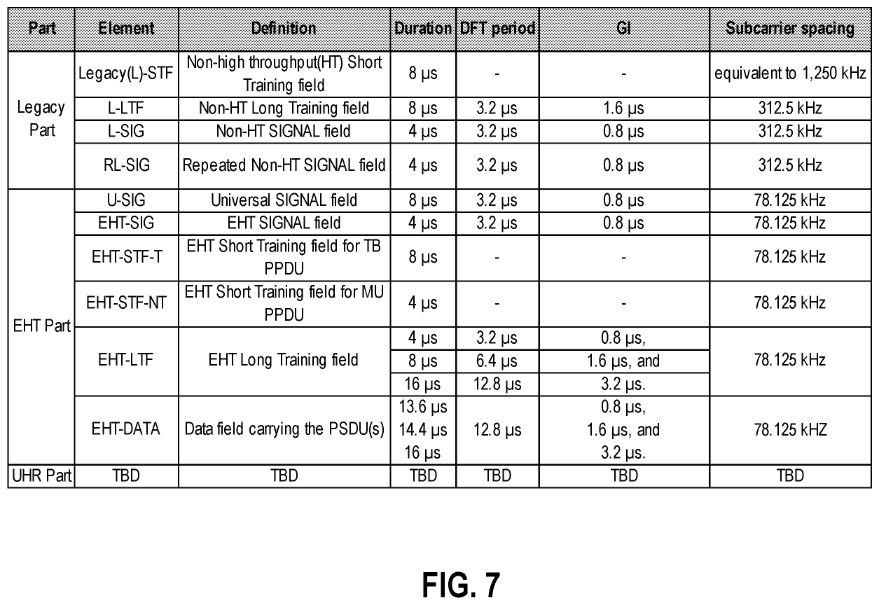

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

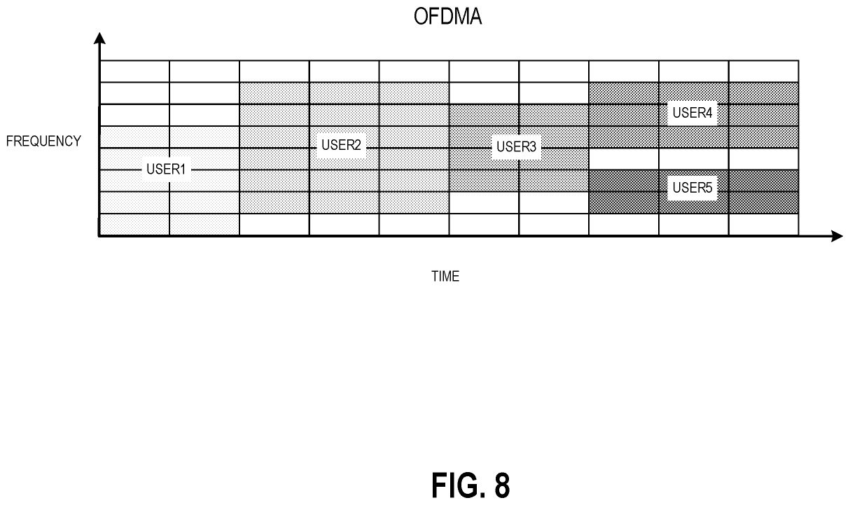

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

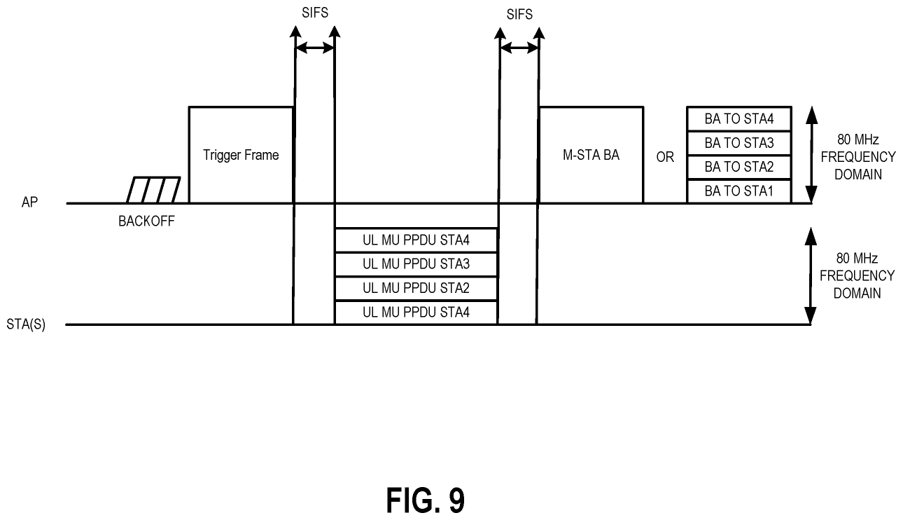

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

In the existing IEEE 802.11ad and IEEE 802.11ay Wi-Fi standards, mmWave channels are used for high data rate transmissions with wide bandwidths. Since mmWave channels have severe propagation loss, it is important to perform directional transmissions using beamforming technology to mitigate against the propagation loss. Accordingly, a beam selection process needs to be performed in the mmWave channel to determine the optimal beam direction in which the transmitter should transmit data to the receiver. The beam selection process may involve the transmitter transmitting multiple training signals in multiple different beam directions and the receiver feeding back an indication of the beam direction that has the highest received signal power at the receiver. Such beam selection process can add significant overheard in mmWave operations.

In the IEEE 802.11bq (integrated millimeter wave (IMMW)) wireless networking standard, support for MLO in the mmWave channel/band and sub-7 GHz channel/band has been proposed. The integration of mmWave and sub-7 GHz channels using MLO technology is regarded as an efficient way to use mmWave channels in IEEE 802.11 wireless networks.

It is recognized by the present disclosure that the overhead of the beam selection process in the mmWave channel can be reduced if the direction from the transmitter to the receiver can be estimated with the aid of a sub-7 GHz channel sounding process. Based on this recognition, the present disclosure describes a new approach to generating and transmitting a NDP frame (and particularly the long training fields (LTFs) that are transmitted as part of the NDP frame transmission) that can be used during a channel sounding process or similar process in a sub-7 GHz channel to allow the transmitter to estimate the direction from the transmitter to the receiver. Once the transmitter has determined the estimated direction from the transmitter to the receiver, the transmitter may perform a beam selection process in the mmWave channel in beam directions that are near the estimated direction (instead of omnidirectionally) to reduce the overhead of the beam selection process.

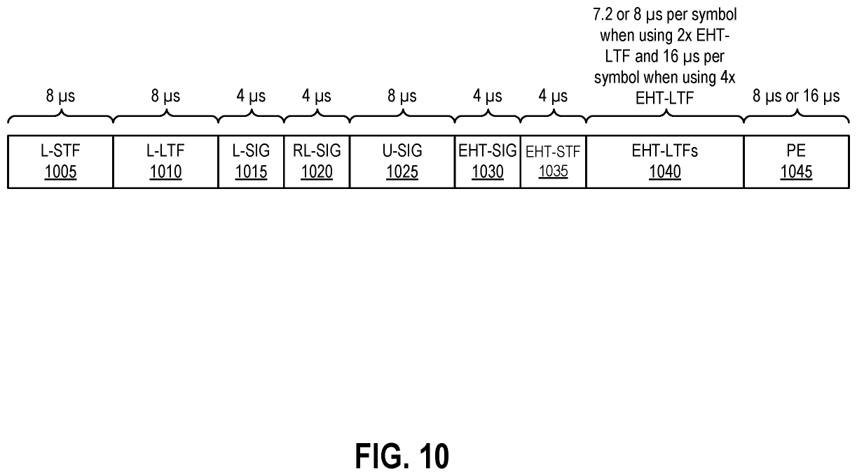

The existing NDP frame is designed to allow estimation of a multiple-input multiple-output (MIMO) channel between a transmitter having multiple antennas and a receiver having multiple antennas. FIG. 10 shows an example format of a NDP frame as defined in the IEEE 802.11be wireless networking standard.

FIG. 10 is a diagram showing a NDP frame format, according to some embodiments. For sake of explanation only, the NDP frame shown in the diagram has a format as defined by the IEEE 802.11be (extremely high throughput (EHT)) wireless networking standard. It should be appreciated that the techniques and concepts disclosed herein can be implemented using a different NDP frame format.

As shown in the diagram, the NDP frame includes a legacy short training field (L-STF) 1005 (8 μs), a legacy long training field (L-LTF) 1010 (8 μs), a legacy signal (L-SIG) field 1015 (4 μs), a repeated legacy signal (RL-SIG) field 1020 (4 μs), a universal signal (U-SIG) field 1025 (8 μs), an extremely high throughput signal (EHT-SIG) field 1030 (4 μs), an extremely high throughput short training field (EHT-STF) 1035 (4 μs), extremely high throughput long training fields (EHT-LTFs) 1040 (7.2 or 8 μs per symbol when using 2× EHT-LTF and 16 μs per symbol when using 4× EHT-LTF), and a packet extension (PE) field 1045 (8 μs or 16 μs).

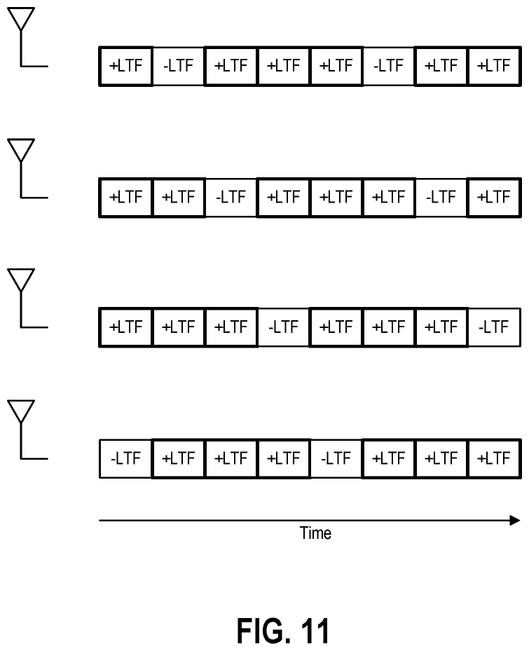

FIG. 11 is a diagram showing four orthogonal LTF streams being transmitted by four antennas, according to some embodiments.

Multiple LTF streams having orthogonal LTF signatures (e.g., P matrix in IEEE 802.11 wireless networking standards) can be transmitted via multiple antennas. LTF streams having orthogonal LTF signatures with respect to each other may be referred to herein as orthogonal LTF streams. The diagram shows an example of four orthogonal LTF streams being transmitted by four antennas, with each LTF stream having eight LTFs. In an embodiment, the orthogonal LTF streams may be carried in a EHT-LTFs field (e.g., field 1040), with other fields of the frame being used in accordance with the EHT wireless networking standard. Orthogonal signatures may be applied to each LTF stream to allow multiple channels to be estimated from multiple transmit antennas. For example, as shown in the diagram, a first antenna may transmit a first LTF stream having a LTF signature/pattern of [+−+++−++], a second antenna may transmit a second LTF stream having a LTF signature/pattern of [++−+++−+], a third antenna may transmit a third LTF stream having a LTF signature/pattern of [+++−+++−], and a fourth antenna may transmit a fourth LTF stream having a LTF signature/pattern of [−+++−+++]. The “+” and “−” in the LTF patterns may refer to whether sign conversions is used or not. Since these LTF signatures/patterns are mutually orthogonal, the channel for each transmit antenna can be separated by matched filtering with the corresponding LTF signature/pattern at the receiver.

The present disclosure describes a new approach to generating and transmitting LTF streams (e.g., as part of a NPD frame transmission) to allow the receiver to feed back information to the transmitter that the transmitter can use to estimate the direction from the transmitter to the receiver. As will be described in additional detail herein, according to some embodiments, instead of transmitting LTF streams with orthogonal signatures via each antenna, the transmitter may apply different steering beam vectors to each orthogonal LTF stream to transmit the orthogonal LTF streams in different beam directions.

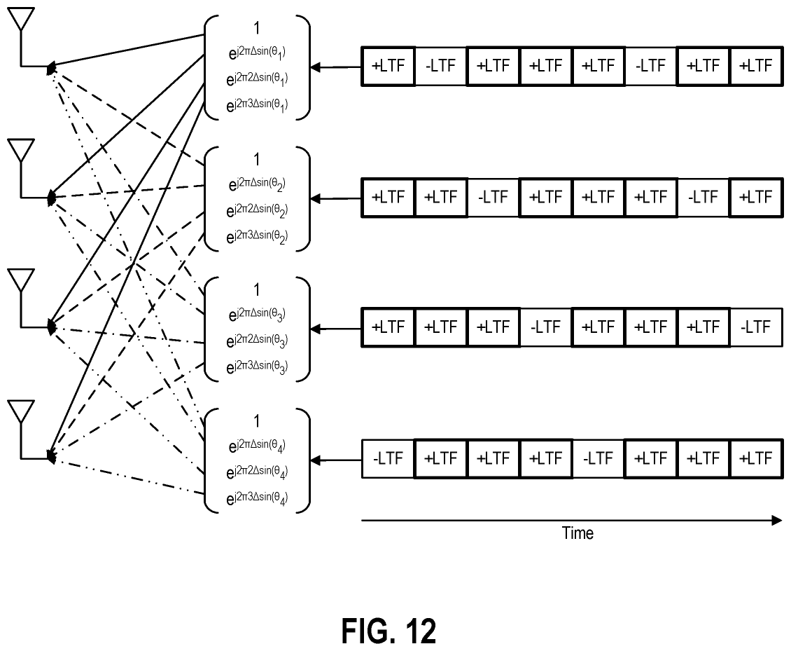

FIG. 12 is a diagram showing four LTF streams being transmitted by a transmitter with four antennas, with different steering beam vectors being applied to each LTF stream, according to some embodiments.

As shown in the diagram, four LTF streams having orthogonal LTF signatures/patterns (with each LTF stream having eight LTFs) can be transmitted by four different antennas, with a different steering beam vector being applied to each LTF stream. Thus, in contrast to the transmission approach shown in FIG. 11 where each LTF stream is transmitted by a single antenna, with the transmission approach shown in FIG. 12, each LTF stream is transmitted by all four antennas but with a different steering beam vector being applied to each LTF stream. A steering beam vector may also be referred to as a beam steering vector (these terms are considered synonymous in the technical field).

In the example shown in the diagram, the steering beam vector that is applied to the first LTF stream may have steering beam coefficients 1, e^{2πΔ sin(θ}^{₁}⁾, e^{2π2Δ sin(θ}^{₁}⁾, and e^{2π3Δ sin(θ}^{₁}⁾, the steering beam vector that is applied to the second LTF stream may have steering beam coefficients 1, e^{2πΔ sin(θ}^{₂}⁾, e^{2π2Δ sin(θ}^{₂}⁾, and e^{2π3Δ sin(θ}^{₂}⁾, the steering beam vector that is applied to the third LTF stream may have steering beam coefficients 1, e^{2πΔ sin(θ}^{₃}⁾, e^{2π2Δ sin(θ}^{₃}⁾, and e^{2π3Δ sin(θ}^{₃}⁾, and the steering beam vector that is applied to the third LTF stream may have steering beam coefficients 1, e^{2πΔ sin(θ}^{₄}⁾, e^{2π2Δ sin(θ}^{₄}⁾, and e^{2π3Δ sin(θ}^{₄}⁾. θ₁, θ₂, θ₃, and θ₄ may correspond to different beam directions and Δ may refer to the spacing between antenna elements.

This means, for example, that the second LTF stream having the [++−+++−+] LTF signature is transmitted by the first antenna with multiplication with steering beam coefficient 1, transmitted by the second antenna with multiplication with a steering beam coefficient e^{j2πΔ sin(θ}^{₂}⁾, transmitted by the third antenna with multiplication with a steering beam coefficient e^{j2π2Δ sin(θ}^{₂}⁾, and transmitted by the fourth antenna with multiplication with a steering beam coefficient e^{j2π3Δ sin(θ}₂⁾. The other LTF streams may be transmitted by the four antennas in a similar manner in accordance with their respective steering beam vectors.

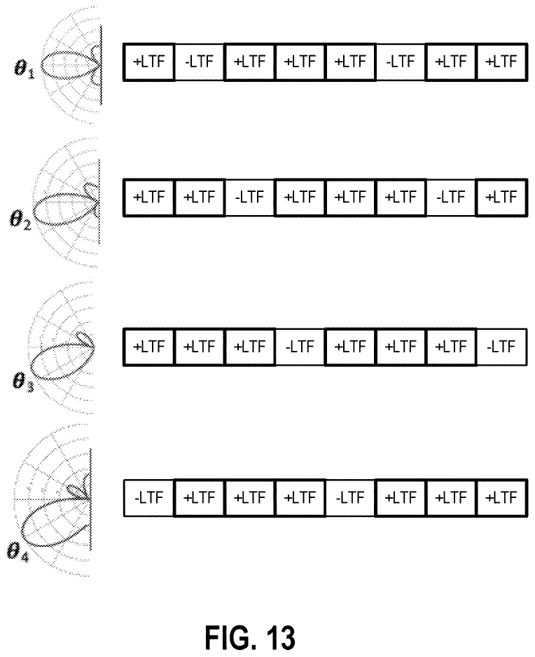

By applying the different steering beam vectors, the four LTF streams can be transmitted in beam directions θ₁, θ₂, θ₃, and θ₄, as shown in FIG. 13.

FIG. 13 is a diagram showing four LTF streams being transmitted in different beam directions, according to some embodiments.

As shown in the diagram, as a result of applying the different steering beam vectors, the first LTF stream is transmitted in a first beam direction corresponding to θ₁, the second LTF stream is transmitted in a second beam direction corresponding to θ₂, the third LTF stream is transmitted in a third beam direction corresponding to θ₃, and the fourth LTF stream is transmitted in a fourth beam direction corresponding to θ₄,

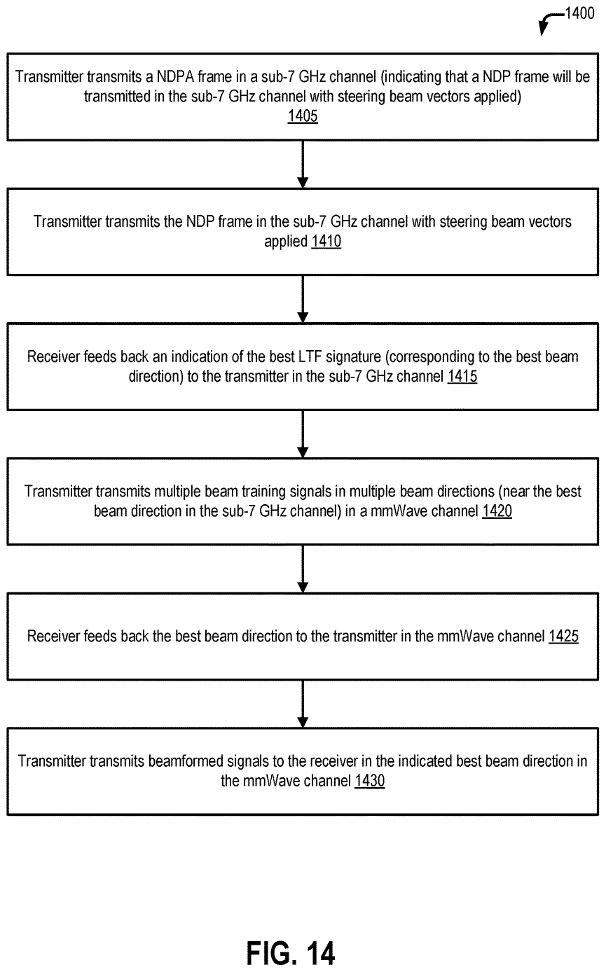

A transmitter may transmit a NDP frame to a receiver in a sub-7 GHz channel using the LTF generation and transmission technique described above. Upon receiving the NDP frame, the receiver may estimate the best beam direction by measuring the received signal power after matched filtering with the corresponding orthogonal LTF signature. Then, the receiver may transmit feedback to the transmitter regarding the best LTF signature (e.g., the LTF signature corresponding to the LTF stream having the highest receive signal power) in the sub-7 GHz channel. The transmitter may estimate the direction from the transmitter to the receiver based on the feedback (e.g., the transmitter may consider the beam direction corresponding to the best LTF signature as being the estimated direction from the transmitter to the receiver). The transmitter may then use the estimated direction from the transmitter to the receiver to reduce the overhead of the mmWave beam selection process. For example, the transmitter may transmit mmWave training signals for the beam selection process near the estimated direction to reduce the number of mmWave training signals that need to be transmitted and processed (and thus reduce the overhead). Also, the mmWave training signals may be transmitted in a more focused direction with finer beam resolution, which can allow for obtaining a more accurate beam direction. An example mmWave beam selection process that uses a sub-7 GHz channel sounding process to reduce the overhead is shown in FIG. 14.

FIG. 14 is a diagram showing a mmWave beam selection process 1400 that uses a sub-7 GHz channel sounding process to reduce overhead, according to some embodiments.

As shown in the diagram, at operation 1405, the transmitter may transmit a null data packet announcement (NDPA) frame in a sub-7 GHz channel. The transmission of the NDPA frame may indicate that a NDP frame transmission in the sub-7 GHz channel is forthcoming. The NDPA frame may include an indication that the NDP frame will be transmitted with steering beam vectors being applied to LTF streams.

At operation 1410, the transmitter may transmit the NDP frame in the sub-7 GHz channel with steering beam vectors being applied to LTF streams.

At operation 1415, the receiver may feed back an indication of the best LTF signature (corresponding to the best beam direction) to the transmitter in the sub-7 GHz channel. Since the LTF streams are orthogonal to each other, the receiver may extract each LTF stream (transmitted in a particular beam direction θₓ) through matched filtering (such process may also be referred to as “correlation”). The best LTF signature may be the LTF signature that corresponds to the LTF stream that had the highest signal quality at the receiver (e.g., had the highest received signal power).

At operation 1420, the transmitter may transmit multiple beam training signals in multiple beam directions (near the best beam direction (the beam direction corresponding to the best LTF signature) in the sub-7 GHz channel) in a mmWave channel.

At operation 1425, the receiver may feed back an indication of the best beam direction (based on processing the multiple beam training signals) to the transmitter in the mmWave channel. Here, the best beam direction may be the beam direction that has the highest received signal power at the receiver.

At operation 1430, the transmitter may transmit beamformed signals to the receiver in the indicated best beam direction in the mmWave channel.

The feedback frame used in the channel sounding process in the sub-7 GHz channel can be modified to feed back information regarding the best LTF signature or best beam direction. If the modification of the feedback frame (that is transmitted by the receiver to the transmitter) is not permitted, the existing compressed beamforming/CQI (channel quality indicator) feedback frame format can be reused. The IEEE 802.11be compressed beamforming/CQI feedback frame includes information regarding the average signal-to-noise ratio (SNR) of each LTF stream (spatial stream). This SNR information can be used to determine the best beam direction. For example, the beam direction corresponding to the LTF stream with the highest average SNR can be considered as the best beam direction. That is, the transmitter may select the beam direction corresponding to the LTF stream with the highest average SNR in the compressed beamforming/CQI feedback frame as corresponding to the best beam direction (and the estimated direction from the transmitter to the receiver for purposes of reducing the overhead of the beam selection process in the mmWave channel).

Also, if the receiver is aware of the steering beam vectors that are applied by the transmitter, the LTF structure of the NDP frame transmitted in the sub-7 GHz channel can be used for two purposes: 1) for the channel sounding of sub-7 GHz links and 2) for the estimation of the receiver direction for the mmWave beam selection process. That is, the NDP frame can be used to fulfill both objectives (to obtain channel state information for a sub-7 GHz channel (e.g., rotation angles and SNR of spatial streams) and determine the estimated direction from the transmitter to the receiver) simultaneously.

The present disclosure describes a new approach to generating and transmitting LTF streams (e.g., as part of a NPD frame transmission in a sub-7 GHz channel) to allow the transmitter to estimate the direction from the transmitter to the receiver based on feedback provided by the receiver. The new LTF generation and transmission approach may apply different steering beam vectors to different orthogonal LTF streams to transmit the orthogonal LTF streams in different beam directions in the sub-7 GHz channel. By using the new LTF generation and transmission approach, the receiver can feed back information to the transmitter that the transmitter can use to estimate the direction from the transmitter to the receiver. The transmitter may leverage this information to reduce the overhead of the beam selection process in the mmWave channel (e.g., by reducing the number of training signals that need to be transmitted) and/or determine the direction from the transmitter to the receiver more accurately (e.g., by being able to transmit training signals near the estimated direction with finer resolution).

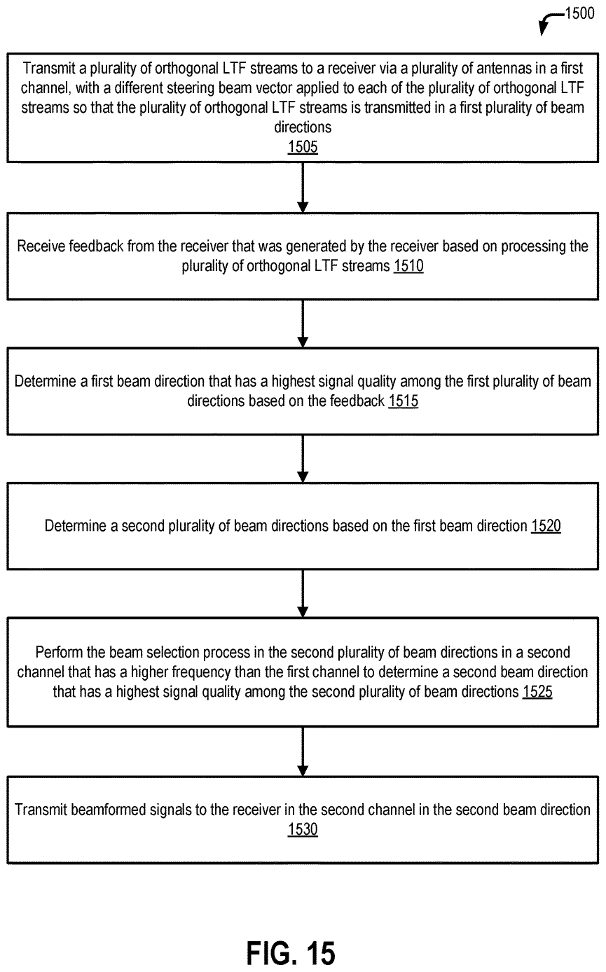

Turning now to FIG. 15, a method 1500 will be described for reducing the overhead of a beam selection process, in accordance with an example embodiment. The method 1500 may be performed by a wireless device (e.g., wireless device 104) acting as a transmitter or beamformer.

Additionally, although shown in a particular order, in some embodiments the operations of method 1500 (and the operations of the other methods described herein) may be performed in a different order. For example, although the operations of method 1500 are shown in a sequential order, some of the operations may be performed in partially or entirely overlapping time periods.

At operation 1505, the transmitter transmits a plurality of orthogonal LTF streams (LTF streams having orthogonal LTF signatures) to a receiver via a plurality of antennas in a first channel, with a different steering beam vector applied to each of the plurality of orthogonal LTF streams so that the plurality of orthogonal LTF stream is transmitted in a first plurality of beam directions.

In an embodiment, the plurality of antennas comprises four antennas, wherein the plurality of orthogonal LTF streams comprises a first LTF stream, a second LTF stream, a third LTF stream, and a fourth LTF stream having orthogonal LTF signatures with respect to each other. In an embodiment, a first steering beam vector is applied to the first LTF stream, a second steering beam vector is applied to the second first LTF stream, a third steering beam vector is applied to the third LTF stream, and a fourth steering beam vector is applied to the fourth LTF stream, wherein the first steering beam vector has steering beam coefficients 1, e^{2πΔ sin(θ}^{₁}⁾, e^{2π2Δ sin(θ}^{₁}⁾ , and e^{2π3Δ sin(θ}^{₁}⁾, the second steering beam vector has steering beam coefficients 1, e^{2πΔ sin(θ}^{₂}⁾, e^{2π2Δ sin(θ}^{₂}⁾, and e^{2π3Δ sin(θ}^{₂}⁾, the third steering beam vector has steering beam coefficients 1, e^{2πΔ sin(θ}^{₃}⁾, e^{2π2Δ sin(θ}^{₃}⁾, and e^{2π3Δ sin(θ}^{₃}⁾, and the fourth steering beam vector has steering beam coefficients 1, e^{2πΔ sin(θ}^{₄}⁾, e^{2π2Δ sin(θ}^{₄}⁾, and e^{2π3Δ sin(θ}^{₄}⁾, wherein θ₁ is a first beam direction of the first plurality of beam directions, θ₂ is a second beam direction of the first plurality of beam directions, θ₃ is a third beam direction of the first plurality of beam directions, and θ₄ is a fourth beam direction of the first plurality of beam directions. Δ may refer to the spacing between antenna elements. In an embodiment, each of the plurality of orthogonal LTF streams includes eight LTF fields.

In an embodiment, the plurality of orthogonal LTF streams is transmitted as part of a NDP frame transmitted in the first channel. In an embodiment, the transmitter transmits a NDPA frame in the first channel before transmitting the NDP frame, wherein the NDPA frame includes an indication that the NDP frame will be transmitted in the first plurality of beam directions.

At operation 1510, the transmitter receives feedback from the receiver that was generated by the receiver based on processing the plurality of orthogonal LTF streams.

At operation 1515, the transmitter determines a first beam direction that has a highest signal quality among the first plurality of beam directions based on the feedback. In an embodiment, the first beam direction is determined to have the highest signal quality among the first plurality of beam directions based on determining that the feedback includes an indication of a LTF signature corresponding to the first beam direction (e.g., the LTF signature of the LTF stream that was transmitted by the transmitter in the first beam direction). In an embodiment, the feedback is received as part of a compressed beamforming/CQI feedback frame received from the receiver in the first channel, wherein the first beam direction is determined to have the highest signal quality among the first plurality of beam directions based on determining that the feedback indicates that a LTF stream corresponding to the first beam direction has a highest average SNR among a plurality of LTF streams.

At operation 1520, the transmitter determines a second plurality of beam directions based on the first beam direction. For example, the second plurality of beam directions may be beam directions that are near the first beam direction (e.g., having a direction/angle that is within a predefined threshold (angular) degrees of the first beam direction).

At operation 1525, the transmitter performs the beam selection process in the second plurality of beam directions in a second channel that has a higher frequency than the first channel to determine a second beam direction that has a highest signal quality among the second plurality of beam directions. In an embodiment, the performing the beam selection process comprises transmitting training signals in the second plurality of beam directions in the second channel and receiving second feedback from the receiver in the second channel that includes an indication of the second beam direction.

At operation 1530, the transmitter transmits beamformed signals to the receiver in the second beam direction in the second channel.

In an embodiment, the transmitter determines channel state information for the first channel based on the feedback (in addition to determining the first beam direction in operation 1515).

In an embodiment, the first channel is a sub-7 GHz channel and the second channel is a mmWave channel.

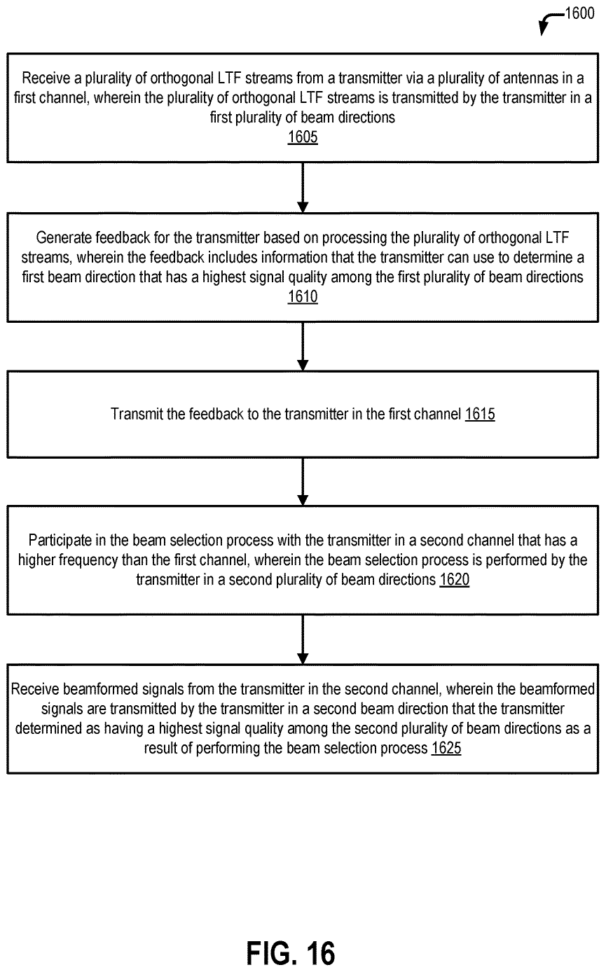

Turning now to FIG. 16, a method 1600 will be described for participating in a reduced overhead beam selection process, in accordance with an example embodiment. The method 1600 may be performed by a wireless device (e.g., wireless device 104) acting as a receiver or beamformee.

At operation 1605, the receiver receives a plurality of orthogonal LTF streams from a transmitter via a plurality of antennas in a first channel, wherein the plurality of orthogonal LTF streams is transmitted by the transmitter in a first plurality of beam directions.

In an embodiment, the plurality of orthogonal LTF streams comprises a first LTF stream, a second LTF stream, a third LTF stream, and a fourth LTF stream having orthogonal LTF signatures with respect to each other. In an embodiment, a first steering beam vector is applied to the first LTF stream, a second steering beam vector is applied to the second first LTF stream, a third steering beam vector is applied to the third LTF stream, and a fourth steering beam vector is applied to the fourth LTF stream, wherein the first steering beam vector has steering beam coefficients 1, e^{2πΔ sin(θ}^{₁}⁾, e^{2π2Δ sin(θ}^{₁}⁾, and e^{2π3Δ sin(θ}^{₁}⁾, the second steering beam vector has steering beam coefficients 1, e^{2πΔ sin(θ}^{₂}⁾, e^{2π2Δ sin(θ}^{₂}⁾, and e^{2π3Δ sin(θ}^{₂}⁾, the third steering beam vector has steering beam coefficients 1, e^{2πΔ sin(θ}^{₃}⁾, e^{2π2Δ sin(θ}^{₃}⁾, and e^{2π3Δ sin(θ}^{₃}⁾, and the fourth steering beam vector has steering beam coefficients 1, e^{2πΔ sin(θ}^{₄}⁾, e^{2π2Δ sin(θ}^{₄}⁾, and e^{2π3Δ sin(θ}^{₄}⁾, wherein θ₁ is a first beam direction of the first plurality of beam directions, θ₂ is a second beam direction of the first plurality of beam directions, θ₃ is a third beam direction of the first plurality of beam directions, and θ₄ is a fourth beam direction of the first plurality of beam directions. Δ may refer to the spacing between antenna elements. The steering beam vectors may be applied by the transmitter. In an embodiment, each of the plurality of orthogonal LTF streams includes eight LTF fields.

In an embodiment, the plurality of orthogonal LTF streams is received as part of a NDP frame received in the first channel. In an embodiment, the receiver receives a NDPA frame in the first channel before receiving the NDP frame, wherein the NDPA frame includes an indication that the transmitter will transmit the NDP frame in the first plurality of beam directions.

At operation 1610, the receiver generates feedback for the transmitter based on processing the plurality of orthogonal LTF streams, wherein the feedback includes information that the transmitter can use to determine a first beam direction that has a highest signal quality (e.g., the highest received signal power) among the first plurality of beam directions. In an embodiment, the processing of the plurality of orthogonal LTF streams comprises applying matched filtering to the plurality of orthogonal LTF streams using LTF signatures of the plurality of orthogonal LTF streams.

At operation 1615, the receiver transmits the feedback to the transmitter in the first channel. In an embodiment, the feedback includes an indication of a LTF signature corresponding to the first beam direction (e.g., the LTF signature of the LTF stream that was transmitted by the transmitter in the first beam direction). In an embodiment, the feedback is transmitted as part of a compressed beamforming/CQI feedback frame transmitted in the first channel, wherein the feedback includes an average SNR of each of a plurality of LTF streams with a LTF stream corresponding to the first beam direction having a highest average SNR among the plurality of LTF streams. In an embodiment, the feedback further includes further information that the transmitter can use to determine channel state information for the first channel.

At operation 1620, the receiver participates in the beam selection process with the transmitter in a second channel that has a higher frequency than the first channel, wherein the beam selection process is performed by the transmitter in a second plurality of beam directions (e.g., beam directions that are near the first beam direction). In an embodiment, the participating in the beam selection process comprises receiving training signals from the transmitter in the second channel, wherein the training signals are transmitted by the transmitter in the second plurality of beam directions, generating second feedback for the transmitter based on processing the training signals, wherein the second feedback includes information that the transmitter can use to determine a second beam direction has a highest signal quality (e.g., highest received signal power) among the second plurality of beam directions, and transmitting the second feedback to the transmitter in the second channel.

At operation 1625, the receiver receives beamformed signals from the transmitter in the second channel, wherein the beamformed signals are transmitted by the transmitter in a second beam direction that the transmitter determined as having a highest signal quality (e.g., highest received signal power) among the second plurality of beam directions as a result of performing the beam selection process.

In an embodiment, the first channel is a sub-7 GHz channel and the second channel is a mmWave channel.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a transmitter in a wireless network to reduce overhead of a beam selection process, the method comprising:
transmitting a plurality of orthogonal long training field (LTF) streams to a receiver via a plurality of antennas in a first channel, with a different steering beam vector applied to each of the plurality of orthogonal LTF streams so that the plurality of orthogonal LTF stream is transmitted in a first plurality of beam directions;
receiving feedback from the receiver that was generated by the receiver based on processing the plurality of orthogonal LTF streams;
determining a first beam direction that has a highest signal quality among the first plurality of beam directions based on the feedback;
determining a second plurality of beam directions based on the first beam direction;
performing the beam selection process in the second plurality of beam directions in a second channel that has a higher frequency than the first channel to determine a second beam direction that has a highest signal quality among the second plurality of beam directions; and
transmitting beamformed signals to the receiver in the second beam direction in the second channel.

2. The method of claim 1, wherein the plurality of antennas comprises four antennas, wherein the plurality of orthogonal LTF streams comprises a first LTF stream, a second LTF stream, a third LTF stream, and a fourth LTF stream having orthogonal LTF signatures with respect to each other.

3. The method of claim 2, wherein a first steering beam vector is applied to the first LTF stream, a second steering beam vector is applied to the second first LTF stream, a third steering beam vector is applied to the third LTF stream, and a fourth steering beam vector is applied to the fourth LTF stream, wherein the first steering beam vector has steering beam coefficients 1, e^{2πΔ sin(θ}^{₁}⁾, e^{2π2Δ sin(θ}^{₁}⁾, and e^{2π3Δ sin(θ}^{₁}⁾, the second steering beam vector has steering beam coefficients 1, e^{2πΔ sin(θ}^{₂}⁾, e^{2π2Δ sin(θ}^{₂}⁾, and e^{2π3Δ sin(θ}^{₂}⁾, the third steering beam vector has steering beam coefficients 1, e^{2πΔ sin(θ}^{₃}⁾, e^{2π2Δ sin(θ}^{₃}⁾, and e^{2π3Δ sin(θ}^{₃}⁾, and the fourth steering beam vector has steering beam coefficients 1, e^{2πΔ sin(θ}^{₄}⁾, e^{2π2Δ sin(θ}^{₄}⁾, and e^{2π3Δ sin(θ}^{₄}⁾, wherein θ₁ is a first beam direction of the first plurality of beam directions, θ₂ is a second beam direction of the first plurality of beam directions, θ₃ is a third beam direction of the first plurality of beam directions, and θ₄ is a fourth beam direction of the first plurality of beam directions.

4. The method of claim 3, wherein each of the plurality of orthogonal LTF streams includes eight LTF fields.

5. The method of claim 1, wherein the plurality of orthogonal LTF streams is transmitted as part of a null data packet (NDP) frame transmitted in the first channel.

6. The method of claim 5, further comprising:
transmitting a null data packet announcement (NDPA) frame in the first channel before transmitting the NDP frame, wherein the NDPA frame includes an indication that the NDP frame will be transmitted in the first plurality of beam directions.

7. The method of claim 1, wherein the first beam direction is determined to have the highest signal quality among the first plurality of beam directions based on determining that the feedback includes an indication of a LTF signature corresponding to the first beam direction.

8. The method of claim 1, wherein the feedback is received as part of a compressed beamforming and channel quality indicator (CQI) feedback frame received in the first channel, wherein the first beam direction is determined to have the highest signal quality among the first plurality of beam directions based on determining that the feedback indicates that a LTF stream corresponding to the first beam direction has a highest average signal-to-noise ratio (SNR) among a plurality of LTF streams.

9. The method of claim 1, wherein the performing the beam selection process comprises:
transmitting training signals in the second plurality of beam directions in the second channel; and
receiving second feedback from the receiver in the second channel that includes an indication of the second beam direction.

10. The method of claim 1, further comprising:
determining channel state information for the first channel based on the feedback.

11. The method of claim 1, wherein the first channel is a sub-7 Gigahertz (GHz) channel and the second channel is a millimeter wave (mmWave) channel.

12. A method performed by a receiver in a wireless network to participate in a beam selection process, the method comprising:
receiving a plurality of orthogonal long training field (LTF) streams from a transmitter via a plurality of antennas in a first channel, wherein the plurality of orthogonal LTF streams is transmitted by the transmitter in a first plurality of beam directions;
generating feedback for the transmitter based on processing the plurality of orthogonal LTF streams, wherein the feedback includes information that the transmitter can use to determine a first beam direction that has a highest signal quality among the first plurality of beam directions;
transmitting the feedback to the transmitter in the first channel;
participating in the beam selection process with the transmitter in a second channel that has a higher frequency than the first channel, wherein the beam selection process is performed by the transmitter in a second plurality of beam directions; and
receiving beamformed signals from the transmitter in the second channel, wherein the beamformed signals are transmitted by the transmitter in a second beam direction that the transmitter determined as having a highest signal quality among the second plurality of beam directions as a result of performing the beam selection process.

13. The method of claim 12, wherein the plurality of orthogonal LTF streams comprises a first LTF stream, a second LTF stream, a third LTF stream, and a fourth LTF stream having orthogonal LTF signatures with respect to each other.

14. The method of claim 13, wherein a first steering beam vector is applied to the first LTF stream, a second steering beam vector is applied to the second first LTF stream, a third steering beam vector is applied to the third LTF stream, and a fourth steering beam vector is applied to the fourth LTF stream, wherein the first steering beam vector has steering beam coefficients 1, e^{2πΔ sin(θ}^{₁}⁾, e^{2π2Δ sin(θ}^{₁}⁾, and e^{2π3Δ sin(θ}^{₁}⁾, the second steering beam vector has steering beam coefficients 1, e^{2πΔ sin(θ}^{₂}⁾, e^{2π2Δ sin(θ}^{₂}⁾, and e^{2π3Δ sin(θ}^{₂}⁾, the third steering beam vector has steering beam coefficients 1, e^{2πΔ sin(θ}^{₃}⁾, e^{2π2Δ sin(θ}^{₃}⁾, and e^{2π3Δ sin(θ}^{₃}⁾, and the fourth steering beam vector has steering beam coefficients 1, e^{2πΔ sin(θ}^{₄}⁾, e^{2π2Δ sin(θ}^{₄}⁾, and e^{2π3Δ sin(θ}^{₄}⁾, wherein θ₁ is a first beam direction of the first plurality of beam directions, θ₂ is a second beam direction of the first plurality of beam directions, θ₃ is a third beam direction of the first plurality of beam directions, and θ₄ is a fourth beam direction of the first plurality of beam directions.

15. The method of claim 14, wherein each of the plurality of orthogonal LTF streams includes eight LTF fields.

16. The method of claim 12, wherein the plurality of orthogonal LTF streams is received as part of a null data packet (NDP) frame received in the first channel.

17. The method of claim 16, further comprising:
receiving a null data packet announcement (NDPA) frame in the first channel before receiving the NDP frame, wherein the NDPA frame includes an indication that the transmitter will transmit the NDP frame in the first plurality of beam directions.

18. The method of claim 12, wherein the feedback includes an indication of a LTF signature corresponding to the first beam direction.

19. The method of claim 12, wherein the feedback is transmitted as part of a compressed beamforming and channel quality indicator (CQI) feedback frame transmitted in the first channel, wherein the feedback includes an average signal-to-noise ratio (SNR) of each of a plurality of LTF streams with a LTF stream corresponding to the first beam direction having a highest average SNR among the plurality of LTF streams.

20. The method of claim 12, wherein the participating in the beam selection process comprises:
receiving training signals from the transmitter in the second channel, wherein the training signals are transmitted by the transmitter in the second plurality of beam directions;
generating second feedback for the transmitter based on processing the training signals, wherein the second feedback includes information that the transmitter can use to determine that the second beam direction has a highest signal quality among the second plurality of beam directions; and
transmitting the second feedback to the transmitter in the second channel.

21. The method of claim 12, wherein the feedback further includes further information that the transmitter can use to determine channel state information for the first channel.

22. The method of claim 12, wherein the processing the plurality of orthogonal LTF streams comprises applying matched filtering to the plurality of orthogonal LTF streams using LTF signatures of the plurality of orthogonal LTF streams.

23. The method of claim 12, wherein the first channel is a sub-7 Gigahertz (GHz) channel and the second channel is a millimeter wave (mmWave) channel.

24. A wireless device configured to act as a transmitter in a wireless network, the wireless comprising:
a radio frequency transceiver;
a memory device storing a set of instructions; and
a processor coupled to the memory device, wherein the set of instructions, when executed by the processor, causes the transmitter to:
transmit a plurality of orthogonal long training field (LTF) streams to a receiver via a plurality of antennas in a first channel, with a different steering beam vector applied to each of the plurality of orthogonal LTF streams so that the plurality of orthogonal LTF stream is transmitted in a first plurality of beam directions;
receive feedback from the receiver that was generated by the receiver based on processing the plurality of orthogonal LTF streams;
determine a first beam direction that has a highest signal quality among the first plurality of beam directions based on the feedback;
determine a second plurality of beam directions based on the first beam direction;
perform a beam selection process in the second plurality of beam directions in a second channel that has a higher frequency than the first channel to determine a second beam direction that has a highest signal quality among the second plurality of beam directions; and
transmit beamformed signals to the receiver in the second channel in the second beam direction.
